(19) United States
(12) Patent Application Publication
(10) Pub. No.: US 2010/0000377 A1
(43) Pub. Date: Jan. 7, 2010

(54) Foot torque

(76) Inventor: Robert Lee Barks, SR., North East, MD (US)

Correspondence Address: ROBERT LEE BARKS SR., 114 S. MAULDIN AVE, NORTH EAST, MD, 21901, US

(21) Appl. No.: 12/387,193

(22) Filed: Apr. 29, 2009

Related U.S. Application Data
(60) Provisional application No. 61/125,774, filed on Apr. 29, 2008.

(51) Int. Cl. B60B 29/00; B25B 23/16; B25B 13/06

(52) U.S. Cl. 81/121.1; 81/177.1

(57) ABSTRACT

“Foot Torque” is a new and improved version of the lug wrench for vehicles. “Foot Torque” far proceeds anything in the market, designed to accomplish the changing of a tire in a much easier, safer, and convenient on almost any vehicle. “Foot Torque” was designed with the intention to change one's tire, but also making it possible for all types of people to use. “Foot Torque” can be used by the elderly, the handicapped, the disabled and even used by people who have never changed a tire in their life. “Foot Torque” is the safest, easiest and most convenient lug wrench anyone could ever use. There is nothing like “Foot Torque” on the market today and if it is put on the market, I am quite positive that people would never consider using anything else again.

I claim priority to the earlier filed Provisional Application. Application No. 61/125,774. Application date (filing) is Apr. 29, 2008.

### BACKGROUND OF INVENTION

My Invention referred to as “Foot Torque” is a basic improvement modification over the standard straight bar single socket lug wrench. A conventional lug wrench is used to remove lug nuts from the wheels of cars, trucks, and other vehicles that have a flat tire that needs changed. Many times a lug nut may be rusted on, or very tight. The conventional lug wrench has a socket on one end that fits over the lug nut. By grasping the other end of the metal lug wrench with one's hand and pulling upwards in usually a counter clockwise direction the person is able to loosen the lug nut on the wheel. Sometimes for older people, females, or people with arthritis, this can be a near impossible task. Even a healthy person can injure a hand, arm, or shoulder when applying heavy force on a conventional lug wrench. “Foot Torque” is designed to eliminate this problem.

### SUMMARY OF INVENTION

“Foot Torque” incorporates a metal foot pedal at the opposite end of the lug nut socket. The foot pedal is used by tapping your foot sharply on the pedal to break the lug nut loose without using your hand, arm, or shoulder, thus avoiding possible strains or injuries to yourself. Your foot, leg, and body weight are used as removal force for the lug nut.

### DESCRIPTION OF DRAWING

FIG. 1. of “foot torque” illustrates a side view showing non slip foot pedal surface. Also, shows socket of various sizes. Construction of steel or other suitable metals.

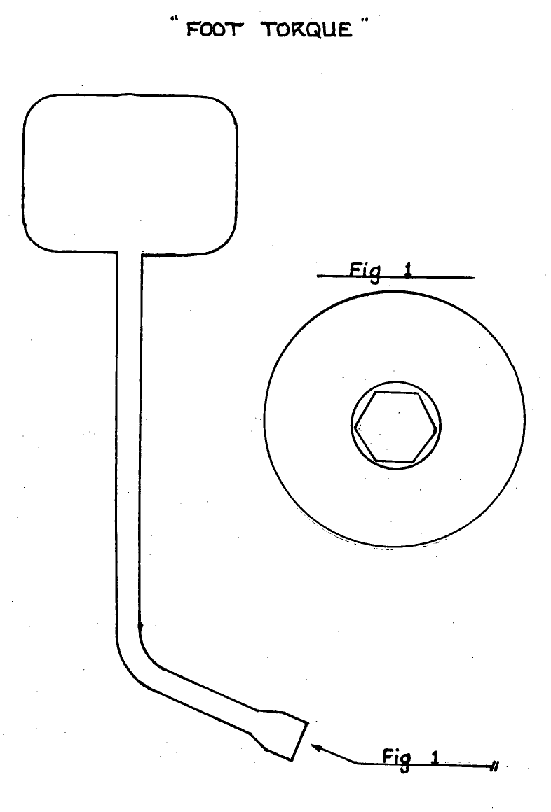

### DETAILED DESCRIPTION OF INVENTION

My invention, referred to as the “foot torque” is a basic straight bar lug wrench with improved modifications. Similar to a conventional straight bar lug wrench, “foot torque” has a permanent socket on one end. The socket may be in various sizes to fit the particular vehicle in which it is supplied. On the opposite end of the “foot torque” is a permanently affixed foot pedal. Both sides of the pedal are covered with a rough grit sandpaper material to prevent one's foot from sliding off when striking it to loosen a lug nut. One side of the pedal is red for tightening and the other side of the pedal is green for loosening. There is a far superior force being used with one's leg, and body weight when sharply stomping down. This has an impact force that is far easier to loosen a tight or rusted lug nut off the wheel.

In summary, my “foot torque” uses a person's foot, leg and body weight to effortlessly loosen a lug nut, as apposed to possibly injuring one's hand, arm, shoulder or forbid their back, while attempting to change a tire.

1. This claim is for my invention. A standard single bar lug wrench with an improved modification. My new improved wrench will make the changing of a tire, on any vehicle, much easier and faster. The “foot torque” is much easier and safer for the elderly, females and the handicapped.

2. In reference to claim number one, “foot torque” has a foot pedal on the opposite side of the socket. The foot pedal is used to conveniently loosen a lug nut with the simple strike of one's foot.

3. The “foot torque” has a color coded pedal with one side red for tightening, and one side green for loosening. The foot pedal has a non slip surface on both sides. Both sides of the pedal have an abrasive “sand paper” surface, making it non-slip when wet or dry. This is in reference to the foot pedal in claim number two.

4. “Foot Torque is constructed of steel or other suitable metals and comes in various sized sockets for the vehicle in which they are supplied. This is in reference to the socket in claim number two.
